(19) United States
(12) Patent Application Publication
(10) Pub. No.: US 2015/0292380 A1
(43) Pub. Date: Oct. 15, 2015

(54) Efficiency and Reduced Emission for Internal Combustion Engines Using Thermoelectric-driven Electrolysis

(71) Applicant: Evident Technologies, Troy, NY (US)

(72) Inventors: Clinton T. Ballinger, Burnt Hills, NY (US); Jack Ballinger, Edwardsville, IL (US); Bed Poudel, Cohoes, NY (US)

(21) Appl. No.: 14/684,919

(22) Filed: Apr. 13, 2015

Related U.S. Application Data
(60) Provisional application No. 61/979,191, filed on Apr. 14, 2014.

(51) Int. Cl. F01N 3/08; C25B 1/04; H01M 8/06; C25B 9/06

(52) U.S. Cl. CPC F01N 3/0892; C25B 9/06; C25B 1/04; H01M 8/0656; H01M 2250/20

(57) ABSTRACT

Disclosed herein is a thermoelectric electrolysis system, the system including a thermoelectric device for deriving electricity from heat, an electrolysis device coupled to the thermoelectric device, an oxygen delivery system connected to the electrolysis device; and a hydrogen delivery system connected to the electrolysis device.

### CROSS-REFERENCE TO RELATED APPLICATIONS

This application claims the benefit of co-pending U.S. Provisional Application Ser. No. 61/979,191, filed 14 Apr. 2014, which is hereby incorporated by reference herein.

### FIELD OF THE INVENTION

Embodiments of the present invention relate generally to improving efficiency and reducing emissions for internal combustion engines utilizing thermoelectric-driven electrolysis

### BACKGROUND OF THE INVENTION

Hydrogen added to the hydrocarbon fuel in internal combustion engines increases the efficiency. Although this is an attractive feature, storage and transport of hydrogen is a problem, greatly reducing the viability of hydrogen injection as a method for increasing fuel economy. Some attempts have been made to use electrolysis of water to create oxygen and hydrogen, onboard an operational vehicle. The hydrogen that is produced has successfully been used as a fuel or an additive to diesel, gasoline, and other internal combustion engines. Addition of H₂ extends the lean burn limit of fuel and increases gas mileage. In addition, hydrogen rich gaseous fuel burned under ultra lean conditions yield very low NOx emissions. Lean burning also limits the CO production.

However, the onboard production of H₂ and O₂ via electrolysis uses more energy than it produces. This has been the subject of many celebrated Internet stories as alternator-driven electrolysis of water will never create more energy than it requires, based on the 2^{nd} law of thermodynamics.

Nevertheless, there are companies that sell electrolysis and hydrogen injection systems for cars. Companies like HHO Kits Direct (www.hhokitsdirect.com) and others sell these systems but they are all driven off of the vehicle's electric system, which means it uses electricity from the alternator driven by the combustion process.

### BRIEF DESCRIPTION OF THE INVENTION

Embodiments of the invention disclosed herein may include a thermoelectric electrolysis system, the system comprising: a thermoelectric device for deriving electricity from heat; an electrolysis device coupled to the thermoelectric device; an oxygen delivery system connected to the electrolysis device; and a hydrogen delivery system connected to the electrolysis device.

Embodiments of the invention may also include a vehicle with said thermoelectric electrolysis system.

### BRIEF DESCRIPTION OF THE FIGURES

FIG. 1 illustrates a thermoelectric electrolysis system according to certain embodiments of the present invention.

FIG. 2 illustrates a thermoelectric electrolysis system according to certain embodiments of the present invention.

It is noted that the drawings may not be to scale. The drawings are intended to depict only typical aspects of the invention, and therefore should not be considered as limiting the scope of the invention. In the drawings, like numbering represents like elements between the drawings. The detailed description explains embodiments of the invention, together with advantages and features, by way of example with reference to the drawings.

### DETAILED DESCRIPTION OF THE INVENTION

Unlike previous attempts of utilizing an electrolysis system for a combustion system, embodiments of the present invention do not violate the laws of thermodynamics. This is accomplished by utilizing the energy from the entire system, e.g., the waste heat from the combustion process is used to power the electrolysis process.

The combustion settings, such as the fuel to air ratio, are typically tied to the exhaust system's oxygen monitoring system in modern vehicles. CO and NOx are undesirable gasses that are produced as part of the combustion process. These gas species are reduced in the catalytic converter in many systems today. These are sophisticated systems that monitor the oxygen levels as an integral operational feature. In fact, the oxygen sensor that is mounted in many catalytic converters will signal for a different fuel/air mixture to keep the oxygen level correct in the catalytic converter. Maximum fuel economy is produced in a narrow range of fuel/air ratios and this is compromised by the needs of the catalytic converter system. Oxygen deprivation in the catalytic converter is the most common situation that arises in typical internal combustion systems and this typically results in a fuel/air ratio that is sub-optimal for fuel-efficiency.

Demand for different fuel/air ratios can be avoided by directly injecting O₂ into the exhaust system on demand. Injection of O₂ will enable the emissions standards to be met or exceeded while keeping the optimal fuel/air ratio. The engine can retain its optimal fuel to air ratio to maintain good gas mileage while the emissions limits are met due to the injection of oxygen directly. The present invention decouples the combustion process optimization from the catalytic converter optimization.

Hydrogen storage can pose a significant problem due to the creation of hazardous conditions and is often cited as one of the reasons why cars are not powered by hydrogen today. Onboard manufacturing of hydrogen via electrolysis is considered by many to be too inefficient. However, to date only electricity produced by the vehicle's alternator has been considered as the electricity source. Embodiments of the present invention use waste heat, for instance from a vehicle's exhaust, to generate electricity via a thermoelectric device, that is used in electrolysis.

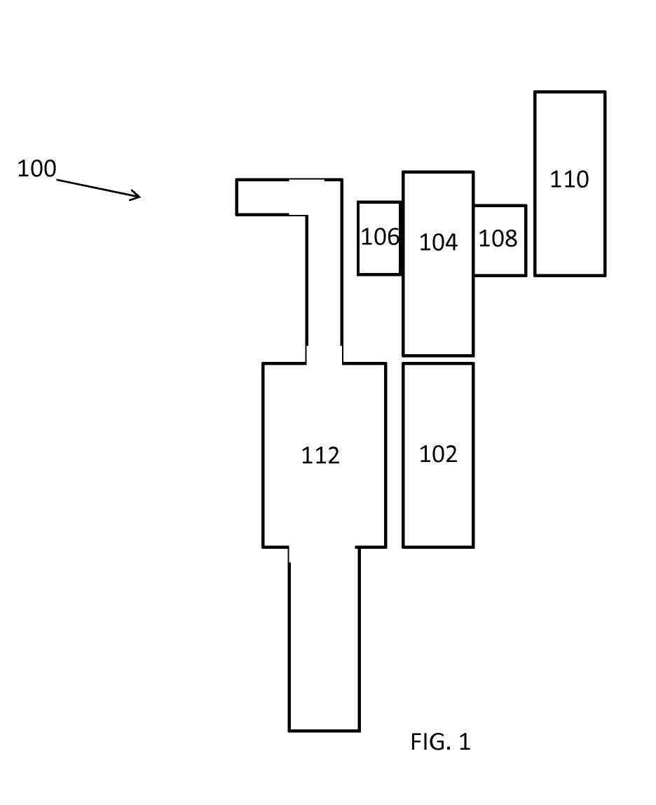

Turning to FIG. 1, embodiments include a thermoelectric electrolysis system 100 that can comprise multiple parts, which as a whole can be used with an internal combustion system, for instance a vehicle. Thermoelectric electrolysis system 100 can include a thermoelectric device 102, described further below, for deriving electricity from heat. Coupled to thermoelectric device is an electrolysis device 104, further described below, for providing electrolysis of water. Connected to electrolysis device 104 is an oxygen delivery system 106 for delivering the oxygen derived from electrolysis. Also connected to electrolysis device 104 is a hydrogen delivery system 108 for delivering the hydrogen derived from electrolysis. Aspects of these features will be further described below in reference to the embodiments disclosed.

In order to understand the benefit of thermoelectric electrolysis system 100, a calculation of energy created is described. The complete electrolysis of 18 grams (g) of water (18 milliliters (mL)) results in 22.4 liters (L) of H₂ and 11.2 L of O₂ produced at standard temperature and pressure (STP). Using 13 Megajoules (MJ) of electricity, one can perform electrolysis on 1000 g, or 1 L, of water to produce enough H₂ to give 15.7 MJ of combustion energy. In some embodiments of the present invention, the electricity required for the electrolysis can be generated from energy that was already considered wasted energy, i.e. heat from the exhaust of an engine. Accordingly, the fuel efficiency can be improved in internal combustion engines if hydrogen is injected before the combustion process. Embodiments of the present invention could include an electrolysis device 104 that utilizes heat from the exhaust to hydrolyze water, injecting the H₂ into the fuel or engine and O₂ into the exhaust or catalytic converter via hydrogen delivery system 108 and oxygen delivery system 106.

The catalytic conversion process of toxic gases is controlled by the oxygen level in the catalytic converter, along with other factors like temperature. Current automotive systems typically require a change in the fuel to air ratio to preserve the amount of oxygen in the catalytic converter. O₂ injection also allows for optimal fuel/air mix in the combustion process because the oxygen deprived situation that could normally occur is halted because of the introduction of O₂ directly. Embodiments of the present invention decouple these two by filling the demand for more oxygen in the catalytic converter with direct injection of oxygen, using oxygen delivery system 108, from the electrolysis of water via electrolysis device 104. As an example, assume you start with 27.8 moles of O₂. This is equivalent to 623 L of O₂ at STP. It has been suggested that if oxygen is added at less than 4 L/min, the emission of CO and NOx are reduced if the proper adjustments are made to the vehicle's fuel air system. Hence, 623 L of O2 will last approximately 156 minutes if injected at 4 L/min rate. The molecular weight of water is 18 g/mole, so 1000 g of water are required to produce 27.8 moles of O₂. Thus, the rate of electrolysis necessary to sustain this level is approximately 1000 g/156 min, or approximately 6.4 g/min. Using 13 MJ/1000 g to electrolysis water, the electrical power required would be 1389 watts (W) to perform electrolysis on 6.4 g/min. This power output is consistent with many modern designs of waste-heat driven thermoelectric systems. Keep in mind this calculation is based on the maximum oxygen injection rate given in a study, and the actual amount of power required may be less.

Some research has been done on using thermoelectric capabilities to convert waste heat from internal combustion to electricity. Nearly all of these have focused on using the electricity produced to augment or replace the vehicle's alternator that is mechanically driven from the engine. Embodiments of the present invention disclose an alternative use for the thermoelectrically generated electricity in that it is used for electrolysis of water. Removing the alternator may increase the vehicle's fuel efficiency; however the addition of H₂ into the fuel stream and injecting O₂ into the exhaust stream can result in a larger increase in efficiency, as well as reducing harmful emissions in the exhaust by controlling the fuel mixture at the engine and the air mixture at the catalytic converter.

Returning to FIG. 1, the above described features of thermoelectric electrolysis system 100 can be further described with reference to the whole of the system. For instance, thermoelectric device 102 may be any now known or later developed thermoelectric device, which includes any device capable of creating voltage when a temperature variance occurs across two sides of the device, referred to as a warm side and a cool side. Electrolysis device 104 may be any device capable of decomposing water into hydrogen and oxygen via an electric current. Electrolysis device 104 may be coupled to thermoelectric device 102 by any means, wherein the current derived in thermoelectric device 102 is transferred to electrolysis device 104 to be used in the electrolysis. Oxygen delivery system 106 and hydrogen delivery system 108 may be coupled to electrolysis device 104 by any means capable of transferring the hydrogen and the oxygen to the respective delivery system from electrolysis device 104.

Further referring to FIG. 1, hydrogen delivery system 108 may be coupled to an injector 110 of an engine. Injector 110 can include any now known or later developed fuel injector. Hydrogen delivery system 108 may be designed to inject H₂ into a fuel stream of existing injector 110, or injector 110 may be built to accept coupling to hydrogen delivery system 108. It should be understood that hydrogen delivery system 108 and injector 110 may include a single part designed for both aspects of fuel injection and H₂ addition, or may be made of multiple parts. In some embodiments, hydrogen delivery by hydrogen delivery system 108, may be capable of suppressing a lean burn limit of the engine. Some engines have lean burn limits, typically included by the manufacturer, however thermoelectric electrolysis system 100 may be capable of suppressing this limit, via a control system or the like. The disclosed hydrogen delivery can also reduce an amount of fuel required for combustion, as a portion of this fuel is replaced by the hydrogen being delivered.

In some embodiments, oxygen delivery system 106 is coupled to an exhaust system 112 of a vehicle. Exhaust system 112 can include any now known or later developed exhaust systems, which can comprise mufflers, tubing, catalytic converters, and other parts of a typical exhaust system in any combination or design. Exhaust system 112 may be modified to accept O₂ delivery from oxygen delivery system 106, or a new exhaust system 112 may be designed to couple with oxygen delivery system 106. In either case, oxygen delivery to exhaust system 112 can reduces the CO emission as well as the NOx emission that results from the internal combustion.

In some embodiments, thermoelectric device 102 is in contact with exhaust system 112. Thermoelectric device 102 may be in contact with any portion of exhaust system 112 that heats from the exhaust. This may be accomplished by any means of connecting or mounting thermoelectric device 102 to exhaust system 112. It should be understood that thermoelectric device 102 can be in contact with any portion of a vehicle that gets warmer than the surrounding environment, but being in contact with exhaust system 112 allows for a plentiful source of heat and reduces materials necessary for providing hydrogen and oxygen to respective parts of the vehicle. In these embodiments, heat from exhaust system 112 heats the thermoelectric device.

In some embodiments, thermoelectric device 102 is cooled on one side. Thermoelectric devices operate by creating energy using a temperature variance. While thermoelectric device 102 can produce electricity by being in contact with a heat source such as exhaust system 112, the surrounding environment would produce some electricity simply by being cooler than the exhaust. However, providing an even cooler source can increase production of electricity by thermoelectric device 102. For instance, some form of cooling can be used in contact with a cool ‘side’ of thermoelectric device 102. This can include water stored for electrolysis, i.e., the water stored to undergo electrolysis by electrolysis device 104. The cooling can also include a coolant system of a vehicle which is adapted to be in contact with thermoelectric device 102. Cooling of thermoelectric device 102 is not illustrated in FIG. 1, as any number of designs can be used to cool one side of thermoelectric device, including contact with water storage or a portion of coolant system of a vehicle, as described above.

In some embodiments, the water for electrolysis can be supplied by any now known or later developed means of supplying water to a vehicle. For instance, the water may be provided by collecting condensate from an air-conditioning system, the water may be recovered from combustion, purified water from a coolant system may be provided, or onboard water storage may be utilized, such as jugs or a tank of water provided solely for the purpose of electrolysis. It should be understood that any of the above methods of supplying water may be utilized alone or in any combination.

In some embodiments, thermoelectric electrolysis system 100 may be able to bypass a connection between an oxygen sensor of the exhaust and a fuel to air ratio control of an engine. This may be accomplished in any way now known or later developed, including but not limited to wiring that bypasses these systems of a vehicle, a circuit or control board that communicates with the computer of a vehicle, or a dedicated computer in communication with the vehicle. In some embodiments, thermoelectric electrolysis system 100 includes a computer system or control system that can include sensors and other known features of such a control system, capable of controlling the whole system, alone or in combination with the computer of a vehicle, which may be used to bypass the vehicle's own oxygen sensors or fuel to air ratio controls.

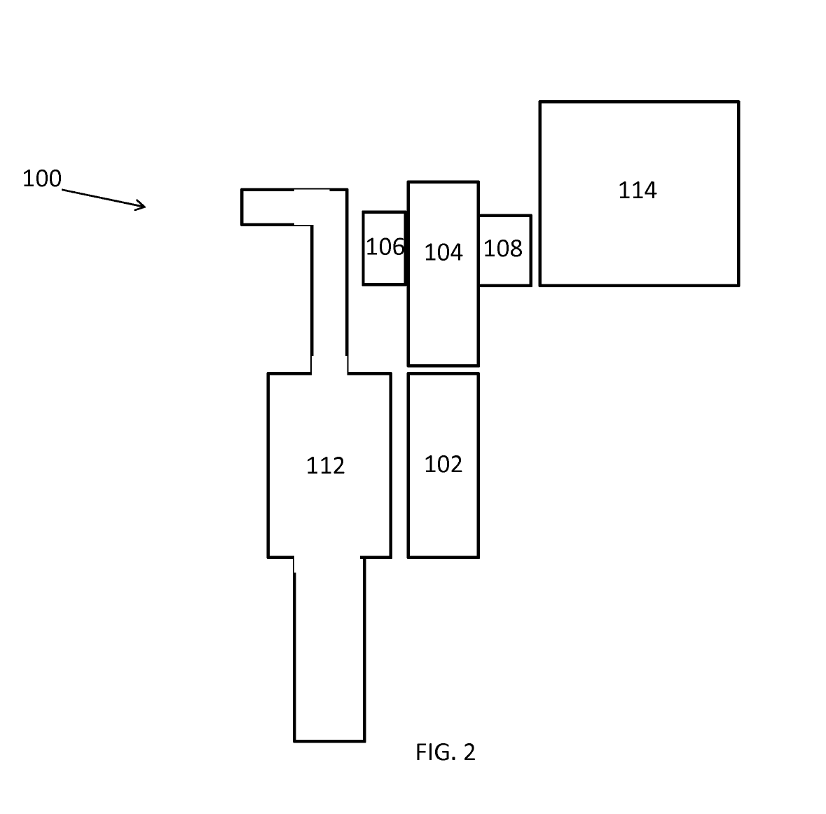

Turning to FIG. 2, hydrogen delivery system can be coupled to a hydrogen storage system 114 for storing the hydrogen produced by electrolysis device 104. Any means of storing hydrogen may be utilized. For instance, hydrogen storage system 114 may include hydrogen fuel cells. In such an embodiment, the hydrogen produced by electrolysis can be used as fuel for a hydrogen driven car. Hydrogen driven cars can include cars fueled solely by hydrogen or “hybrid” cars that use hydrogen and traditional fuel. The hydrogen provided by thermoelectric electrolysis system 100 of these embodiments may be the only source of hydrogen as fuel, or in combination with other forms of providing hydrogen to hydrogen driven cars.

It should be understood that thermoelectric electrolysis system 100, including any or all of the embodiments described above, can be installed in a vehicle. The installation may be done at a manufacturing factory as a part of the design of the vehicle, or thermoelectric system 100 may be a “modification” to the vehicle, installed after or before purchase of the car by a dealership or garage, or even at home. Thermoelectric electrolysis system 100 can be integrated with nearly any type of vehicle, including but not limited to traditional internal combustion vehicles, “hybrid” vehicles including those augmented by hydrogen fuel or electric hybrid vehicles, purely electric vehicles, or hydrogen driven vehicles. It should be understood that thermoelectric electrolysis system 100 may also be utilized with vehicles of different classes, including but not limited to cars, trucks, delivery vehicles, large commercial trucks, motorcycles, and any other vehicle now known or later developed.

In addition, thermoelectric electrolysis system 100 may be utilized with any small engine applications, including but not limited to lawnmowers, riding lawnmowers, weed trimmers, and any other small engine devices now known or later developed. Further, thermoelectric electrolysis system 100 may be used for any engine applications. For instance, marine engine devices and vehicles can benefit from embodiments disclosed herein. As one example, speedboats and other sea vessels can easily incorporate thermoelectric electrolysis system 100. Engines with or without a catalytic converter can utilize embodiments disclosed herein, as well.

The foregoing description of various aspects of the invention has been presented for the purpose of illustration and description. It is not intended to be exhaustive or to limit the invention to the precise form disclosed, and obviously, many modifications and variations are possible. Such variations and modifications that may be apparent to one skilled in the art are intended to be included within the scope of the present invention as defined by the accompanying claims.

What is claimed:

1. A thermoelectric electrolysis system, the system comprising:
a thermoelectric device for deriving electricity from heat;
an electrolysis device coupled to the thermoelectric device;
an oxygen delivery system connected to the electrolysis device; and
a hydrogen delivery system connected to the electrolysis device.

2. The system of claim 1, where the hydrogen delivery system is coupled to an injector of an engine.

3. The system of claim 2, wherein hydrogen delivery suppresses a lean burn limit of the engine.

4. The system of claim 2, wherein hydrogen delivery reduces an amount of fuel required for combustion.

5. The system of claim 1, wherein the oxygen delivery system is coupled to an exhaust system.

6. The system of claim 5, wherein oxygen delivery reduces CO emission.

7. The system of claim 5, wherein oxygen delivery reduces NOx emissions.

8. The system of claim 1, wherein the thermoelectric device is in contact with an exhaust system.

9. The system of claim 8, wherein heat from the exhaust system heats the thermoelectric device.

10. The system of claim 8, wherein the thermoelectric device is cooled by at least one of: water for electrolysis and a coolant system of a vehicle.

11. The system of claim 1, wherein water for electrolysis is supplied to the electrolysis device by at least one of: condensate from an air-conditioning system, water recovered from combustion, purified water from a coolant system, or an onboard water storage.

12. The system of claim 1, wherein the thermoelectric electrolysis system bypasses a connection between an oxygen sensor of the exhaust and a fuel to air ratio control of an engine.

13. The system of claim 1, further comprising:
a hydrogen storage system coupled to the hydrogen delivery system.

14. The system of claim 13, wherein the hydrogen storage system comprises hydrogen fuel cells and the hydrogen produced by electrolysis is used as fuel for a hydrogen driven car.

15. A vehicle with a thermoelectric electrolysis system of claim 1.

16. A small engine device with a thermoelectric electrolysis system of claim 1.

17. A marine vehicle with a thermoelectric electrolysis system of claim 1.
